(19) United States
(12) Patent Application Publication
(10) Pub. No.: US 2008/0010776 A1
(43) Pub. Date: Jan. 17, 2008

(54) Tilt hinge

(76) Inventors: Takayuki Kaneko, Osaka-hu (JP); Kazuo Saitoh, Osaka-hu (JP)

Correspondence Address: NATH & ASSOCIATES, 112 South West Street, Alexandria, VA, 22314, US

(21) Appl. No.: 11/701,553

(22) Filed: Feb. 2, 2007

(30) Foreign Application Priority Data
Feb. 6, 2006 (JP) 2006-028158

(51) Int. Cl. E05F 3/20

(52) U.S. Cl. 16/54

(57) ABSTRACT

A tilt hinge includes a holder which is attached and fixed to an apparatus body such as a laptop personal computer in an integrated manner, a shaft which is attached and fixed to an open/close member such as a display in an integrated manner, a flange portion which is formed with the shaft in an integrated manner and is stored in a cylinder formed on the holder while being able to freely rotate, a resistance plate which is formed with the shaft via the flange portion in an integrated manner, a set screw which is screwed into an internal thread formed on the holder, and viscous fluid which fills a sealed space surrounded by the cylinder, the flange portion, and an apical surface of the set screw.

### BACKGROUND OF THE INVENTION

1. Field of the Invention

The present invention relates to a tilt hinge that connects an apparatus body of a laptop personal computer or the like and an open/close member such as a display while enabling free open/close action of the open/close member. Especially, the present invention relates to a tilt hinge that enables smooth opening/closing of the open/close member by providing torque.

2. Related Art

As conventional tilt hinge, there has been known one in which a plurality of disc springs are intervened in a layered manner between the apparatus body and the open/close member so that the disc springs are pressed with each other by a spring. Thus, friction is generated and the open/close member is enabled to keep an arbitrary angle toward the apparatus body. (For example, refer to the Patent Document 1)

However, in the above mentioned conventional tilt hinge, a plurality of disc springs and a spring are used and therefore, the number of the parts becomes large. In addition, it requires processing and assembly technique with high precision to control pressing adjustment of disc springs by the spring. There is also a disadvantage that the disc springs would be worn away due to long-term use.

Patent Reference 1: Japanese Published Unexamined Patent Application No. 2005-106139

The present invention aims at providing a tilt hinge that can reduce manufacturing cost thereof because the number of parts is reduced and, at the same time, processing and assembly technique with high precision are not required and has no possibility of lowered performance due to long-term use.

### SUMMARY OF THE INVENTION

A tilt hinge of the present invention includes a holder which is attached and fixed to an apparatus body such as a laptop personal computer in an integrated manner, a shaft which is attached and fixed to an open/close member such as a display in an integrated manner, a flange portion which is formed with the shaft in an integrated manner and is stored in a cylinder formed on the holder while being able to freely rotate, a resistance plate which is formed with the shaft in an integrated manner via the flange portion, a set screw which is screwed into an internal thread formed on the holder, and viscous fluid which fills a sealed space surrounded by the cylinder, the flange portion, and an apical surface of the set screw. Moreover, a disc spring is inserted resiliently between the apical surface of the set screw and the resistance plate. The viscous fluid is grease.

Not only can the tilt hinge of the present invention reduce the number of parts, but also it does not require processing and assembly technique with high precision. Also, there is no possibility of lowered performance due to long-term use.

### BRIEF DESCRIPTION OF THE DRAWINGS

FIG. 1 is a cross sectional view showing an embodiment example of a tilt hinge of the present invention.

FIG. 2 is an exploded perspective view of FIG. 1.

### DESCRIPTION OF THE PREFERRED EMBODIMENTS

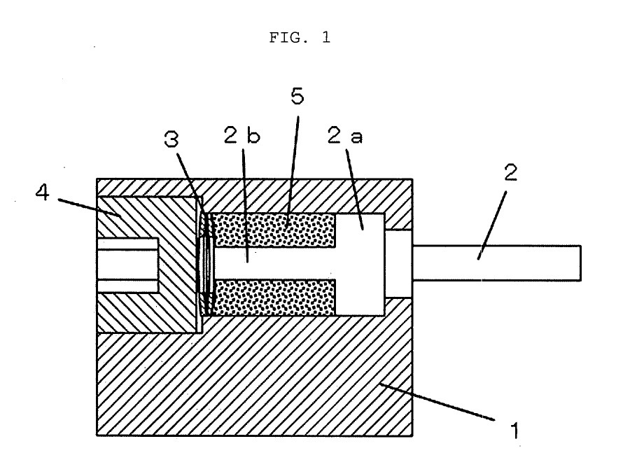

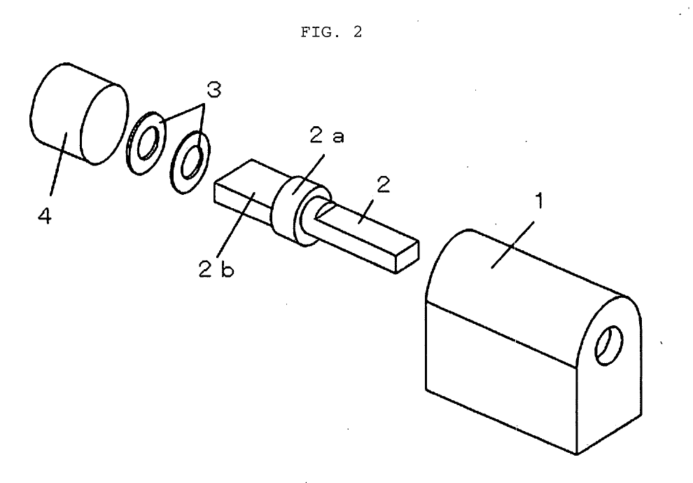

FIGS. 1 and 2 show an embodiment of a tilt hinge of the present invention. 1 is a holder, 2 is a shaft, 2a is a flange portion, 2b is a resistance plate, 3 is a disc spring, 4 is a set screw, and 5 is viscous fluid such as grease.

The holder 1 is attached and fixed to an apparatus body such as a laptop personal computer (not shown) in an integrated manner.

The shaft 2 is attached and fixed to an open/close member such as a display (not shown) in an integrated manner.

The flange portion 2a is formed with the shaft 2 in an integrated manner and is stored in a cylinder 1a formed on the holder 1 while being able to freely rotate.

The resistance plate 2b is formed with the shaft 2 in an integrated manner via the flange portion 2a and rotates with the shaft 2 and the flange portion 2a in an integrated manner.

The set screw 4 is screwed into an internal thread 1b formed on the holder 1. A disc spring 3 is inserted resiliently between the apical surface of the set screw 4 and the resistance plate 2b. Thanks to the disc spring 3, position of the shaft 2 in an axial direction is fixed.

A sealed space S surrounded by the cylinder 1a, the flange portion 2a, and the apical surface of the set screw 4 is filled with viscous fluid 5 such as grease. The viscous fluid 5 is pressurized by the set screw 4.

Because the tilt hinge of the present embodiment is structured as above, when an open/close member such as a display is opened/closed to turn the shaft 2, the resistance plate 2b which is to be turned together with the shaft 2 receives resistance from the viscous fluid 5 which is pressurized in the sealed space S and, as a result, the shaft 2 is turned while receiving torque resistance. When open/close action of the open/close member is stopped, the resistance plate 2b retains the position at that point in time due to the viscous fluid 5.

### DESCRIPTION OF THE REFERENCE NUMERALS

1 Holder
1a Cylinder
1b Internal thread
2 Shaft
2a Flange portion
2b Resistance plate
3 Disc spring
4 Set screw
5 Viscous fluid
S Sealed space

What is claimed is:

1. A tilt hinge comprising:
a holder which is attached and fixed to an apparatus body such as a laptop personal computer in an integrated manner, a shaft which is attached and fixed to an open/close member such as a display in an integrated manner,
a flange portion which is formed with the shaft in an integrated manner and is stored in a cylinder formed on the holder while able to freely rotate,
a resistance plate which is formed with the shaft in an integrated manner via the flange portion,
a set screw which is screwed into an internal thread formed on the holder, and
viscous fluid which fills a sealed space surrounded by the cylinder, the flange portion, and an apical surface of the set screw.

2. The tilt hinge as claimed in claim 1, wherein a disc spring is inserted resiliently between the apical surface of the set screw and the resistance plate.

3. The tilt hinge as claimed in claim 2, wherein the viscous fluid is grease.

4. The tilt hinge as claimed in claim 1, wherein the viscous fluid is grease.
